(19) United States
(12) Patent Application Publication
(10) Pub. No.: US 2013/0002598 A1
(43) Pub. Date: Jan. 3, 2013

(54) Circuits and Methods for Tracking Multiple Objects Relative to a Touch-Sensitive Interface

(76) Inventors: Victor Phay Kok Heng, Punggol (SG); Soh Kok Hong, Serangoon (SG)

(21) Appl. No.: 13/174,481

(22) Filed: Jun. 30, 2011

(51) Int. Cl. G06F 3/044; G08C 21/00

(52) U.S. Cl. 345/174; 178/20.01; 178/18.03; 178/20.02; 178/18.01

(57) ABSTRACT

An integrated circuit includes a processor configured to receive position data corresponding to positions of objects relative to a touch-sensitive interface. The processor is configured to determine a first index point for the position data and a second index point of previous position data corresponding to previous positions of the objects relative to the touch-sensitive interface. The processor aligns the first and second index points and assigns an index to link the positions of the objects to the previous positions based on distances between the objects in the position data relative to the previous position data.

### FIELD

The present disclosure is generally related to tracking multiple moving objects on a touch-sensitive interface, such as a capacitive touch screen.

### BACKGROUND

Devices with touch-sensitive interfaces utilize various types of circuits for detecting object proximity or contact with the touch-sensitive interface. One type of touch sensor circuit is a capacitor array, which has become increasingly popular for receiving such user input. Typically, dedicated sensing circuitry couples to the capacitive array for detecting changes in the capacitance of one or more capacitors in the array indicating a position of the object, enabling a user to input particular information by interacting with the touch-sensitive interface.

Regardless of the specific method for detecting the user input, touch screen circuitry monitors the changes with respect to an electrical parameter (such as voltage, current, capacitance, and the like) to determine the location of an object relative to the touch-sensitive interface. With capacitive array touch screens, circuitry determines of the X and Y coordinate location of a single object based on measured electrical parameters associated with various locations on the touch-sensitive interface, such as with respect to particular rows and columns within a capacitive array. The circuitry tracks movement of the single object based on changes in capacitance over time. When multiple objects contact the touch-sensitive interface, the circuitry detects multiple contact locations and tracks multiple movements.

### SUMMARY

In an embodiment, an integrated circuit includes a processor configured to receive position data corresponding to positions of objects relative to a touch-sensitive interface. The processor is configured to determine a first index point for the position data and a second index point of previous position data corresponding to previous positions of the objects relative to the touch-sensitive interface. The processor aligns the first and second index points and assigns an index to link the positions of the objects to the previous positions based on distances between the objects in the position data relative to the previous position data.

In another embodiment, a method of tracking multiple objects relative to a touch sensitive interface includes determining a first center point among the multiple objects from first position data captured at a first time and determining a second center point among the multiple objects from second position data captured at a second time previous to the first time. The method further includes transposing the second position data with the first position data based on the second and first center points to form aligned position data and assigning an index to relate the multiple objects of the first position data to the multiple objects of the second position data based on their relative distances within the aligned position data.

In still another embodiment, a system includes a touch-sensitive interface for receiving user input and an integrated circuit coupled to the touch-sensitive interface. The integrated circuit includes an interface configurable to couple to the touch-sensitive interface and a sensor circuit coupled to the interface. The sensor circuit is configured to sense a change in an electrical parameter corresponding to positions of multiple objects relative to the touch-sensitive interface and to generate position data corresponding to the positions of the multiple objects. The integrated circuit further includes a processor coupled to the sensor circuit and configured to determine relative motion of the multiple objects. The processor is configured to align a first center point of the first position data with a second center point of the second position data, to calculate distances between the multiple objects in the first and second position data, and to link the multiple objects in the second position data to the multiple objects in the first position data based on the distances.

### BRIEF DESCRIPTION OF THE DRAWINGS

FIG. 1 is a block diagram of a system including a circuit for tracking multiple objects on a touch screen.

FIG. 2 is a graph illustrating previous position data and current position data for multiple objects on a touch screen on an X-Y coordinate axis.

FIG. 3 is a graph illustrating a resulting indexing of the current position data to the previous position data of the position data of FIG. 2 based on a conventional distance calculation, causing one of the objects to appear to change position arbitrarily.

FIG. 4 is a graph illustrating center points of the previous position data and the current position data of the position data of FIG. 2.

FIG. 5 is a graph illustrating a transposition (alignment) of the current position data to the previous position data by aligning the center points of FIG. 4.

FIG. 6 is a graph illustrating the resulting indexing of the current position data to the previous position data based on the distances between the objects determined from the transposed positions of FIG. 5.

FIG. 7 is a flow diagram of a method for tracking multiple objects on a touch screen.

In the following description, the use of the same reference numerals in different drawings indicates similar or identical items.

### DETAILED DESCRIPTION OF ILLUSTRATIVE EMBODIMENTS

Circuits and methods are described below for tracking multiple objects on a touch screen over time. In an example, a circuit includes an interface configurable to couple to a capacitive array of a touch screen interface for detecting position data related to one or more objects contacting the touch screen. The circuit further includes a capacitive sensor circuit configured to measure a capacitance associated with one or more capacitors of the capacitive array and a processor configured to process signals from the capacitive sensor circuit to determine current position data associated with the one or more objects. The processor determines an center point for the multiple objects based on the position data and a second center point for previous position data associated with the one or more objects. In an example, the first and second center points can be the center points corresponding to a center position among the multiple objects. In another example, the first and second center points can be center points of a geometric shape, such as a rectangle, circle, or other geometric shape, that circumscribes the multiple objects. In a particular example, each of the first and second center points represents a point among the multiple objects that has a minimum distance relative to the multiple objects. The processor transposes the current positions with the previous positions by aligning the center points and then calculates the distances between the current position data and the previous position data, assigning the index to the current position data based on the distances. In a particular example, the index is assigned to the current position data using a shortest Euclidean distance approach.

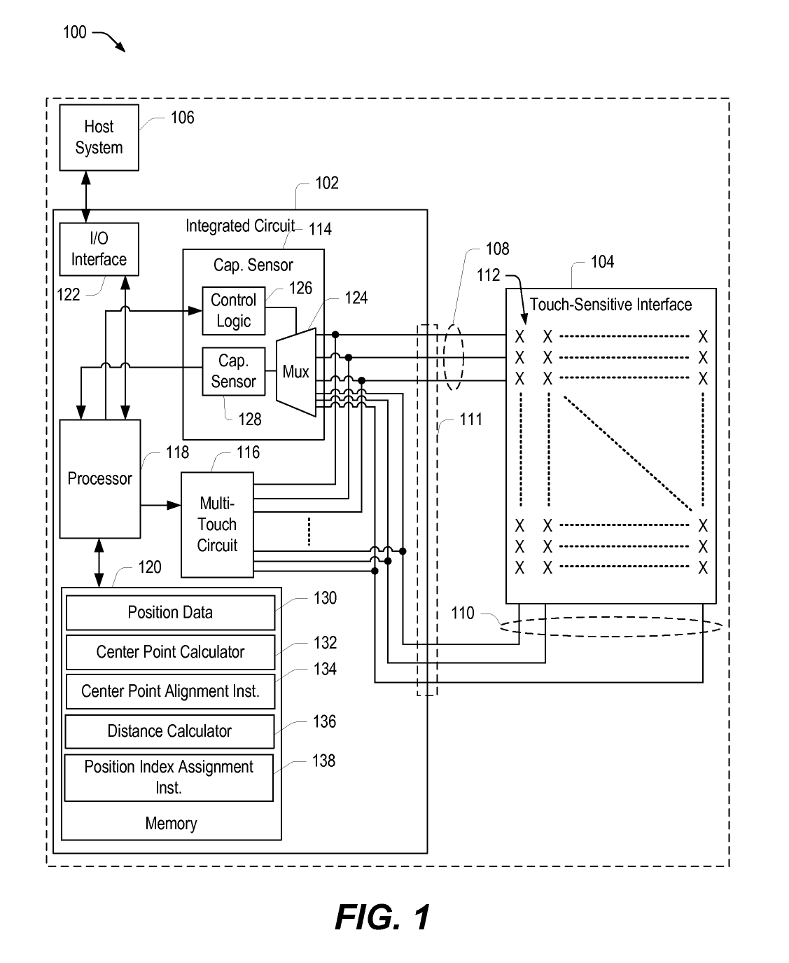

By determining distances after transposition of the previous position data and the current position data, mapping (indexing or linking) of the objects from one time to a next time is improved, reducing instances of new indexes, arbitrary re-indexing, and/or incorrect mapping of moving objects. For gesture recognition and multiple contact inputs (such as pinch/grab type of input gestures), correct indexing of object position over time enhances the user experience and improves the reliability of user input via the touch screen. An example of a circuit for tracking multiple objects on a touch screen is described below with respect to FIG. 1.

FIG. 1 is a block diagram of a system 100 including an integrated circuit 102 for tracking multiple objects on a touch-sensitive interface 104. The touch-sensitive interface 104 is includes a capacitive array 112, which are formed by conductive wire traces forming rows 108 and columns 110, where the capacitors are formed by the intersections of the rows 108 and columns 110. In the illustrated example, wire traces forming rows 108 extend horizontally across the touch-sensitive interface 104 and cross each of the wire traces forming columns 110, which extend vertically across the touch-sensitive interface 104. The rows 108 and columns 110 of the capacitive array 112 couple to an input/output (I/O) interface 111 of integrated circuit 102.

Integrated circuit 102 includes a capacitive sensor circuit 114 coupled to I/O interface 111. Capacitive sensor circuit 114 includes an input coupled to an output of a processor 118, and an output coupled to an input of processor 118. Processor 118 is coupled to I/O interface 122, which is adapted to couple to a host system 106. Processor 118 is also coupled to a memory 120 and to a multi-touch circuit 116.

System 100 may be a personal digital assistant, a portable computing device, a track pad, a cell phone, a smart phone, or other data processing device configured to receive user input via touch-sensitive interface 104. Further, touch-sensitive interface 104 can be integrated with a display with an embedded or attached touch-sensitive circuit. Alternatively, touch sensitive interface 104 may be used in a non-display-based product, such as a track pad, a keypad, or another type of contact-sensitive device for receiving user inputs. In a particular example, the touch-sensitive interface 104 is configured to detect gestures based on changes in capacitance over time.

Capacitive sensor circuit 114 includes a multiplexer 124 including multiple inputs coupled to interface 111, a control input coupled to an output of a control logic circuit 126, and an output coupled to an input of a capacitive sensor 128. Control logic circuit 126 includes an input coupled to one of the outputs of processor 118. Capacitive sensor 128 includes an output coupled to the input of processor 118.

Multi-touch circuit 116 includes an input coupled to an output of processor 118 and multiple lines coupled to rows 108 and columns 110. Multi-touch circuit 116 may include a multiplexer and a signal generator as well as sense circuitry and is responsive to control signals from processor 118 to selectively generate a pulse or signal for output to each of the column lines and then monitor all the row lines to determine the size of the row-to-column capacitor based on the charge stored therein. In an example, multi-touch circuit 116 applies a pulse onto a particular column line, for example, which causes a charge to be transferred from the row-to-column capacitor to capacitive sensor circuit 114, which determines the charge. The capacitance value for the row-to-column capacitor changes (decreases) in response to an object proximate to the particular capacitive intersection. Multi-touch circuit 116 can be utilized to make a determination as to which row 108 or column 110 was actually touched in order to resolve any ambiguities when multiple touches on the screen occur. Further, it is possible to scan only a portion of the touch-sensitive interface 104 in any one of the two modes. In an embodiment, the rows 108 and columns 110 can be monitored at substantially the same time.

Memory 120 stores position data 130 corresponding to previous positions of objects relative to touch-sensitive interface 104. Memory 120 also stores instructions that, when executed by processor 118, cause processor 118 to track movement of multiple objects relative to the touch-sensitive interface 104. Memory 120 includes center point calculator instructions 132 that, when executed by processor 118, causes processor 118 to retrieve previous position data 130 and to calculate an center point for the current position data and the previous position data. In an example, the center point represents a center point among multiple objects. Alternatively, the center point can be selected to be some other position relative to the multiple objects. Memory 120 also includes center point alignment instructions 134 that, when executed, causes processor 118 to transpose the current position data with the previous position data by aligning their respective center points in an X-Y plane. Memory 120 further includes distance calculator instructions 136 that, when executed, cause processor 118 to determine distances between one or more objects based on the aligned current and previous position data. Memory 120 also includes position index assignment instructions 138 that, when executed, cause processor 118 to assign an index to current positions from the current position data. In an example, the processor 118 determines a shortest distance between a previous position and a current position for each of the multiple objects and indexes the current position to the previous position based on the shortest distance.

If two objects have the same distance relative to an object within the previous position data, processor 118 uses position index assignment instructions 138 to disambiguate the assignment and to link the current position of the object to the previous position of the object. In a particular instance, processor 118 executes position index assignment instructions 138 to determine a next shortest distance between each of the two objects and another object within previous position data. Processor 118 then indexes the current position data based on the next shortest distance, for example, assuming than one object may move further than another between measurements. In an example, the current position data is indexed or linked to the previous position data by determining a shortest distance between the current positions and the previous positions.

In a touch-sensitive interface that uses mutual capacitance, capacitive array 112 includes a two-layer grid of spatially separated wires (rows 108 and columns 110), which are separated by a dielectric. During operation, the rows 108 are charged and the charge capacitively couple to the columns 110 at each of the intersections. As an object approaches the surface of the touch device, the object capacitively couples to the rows 108 at the intersections in close proximity to the object, altering the charge stored by the capacitors formed by the intersection of the rows 108 and columns 110 proximate to the object. The amount of charge in each of the capacitors can be measured by capacitive sensor circuit 114 to determine the positions of multiple objects relative to the touch-sensitive interface.

Alternatively, the sensing can be based on self capacitance or mutual capacitance. In a touch-sensitive interface that uses self capacitance, each capacitor is provided by an individually charged electrode (wire trace) and the object itself. As an object approaches the surface of the touch-sensitive interface 104, the object capacitively couples to electrodes in close proximity to the object, detectably altering the charge on the electrodes. The amount of charge in each of the electrodes can be measured by the sensing circuit to determine the position of one or more objects relative to the surface of the touch-sensitive interface 104.

In an example processor 118 interacts with control logic 126 to control capacitive sensor circuit 114 to scan rows 108 and/or columns 110 to detect changes in the capacitance. If processor 118 detects a change in the capacitance, it determines that some object has approached or contacted the touch-sensitive interface 104. Processor 118 evaluates capacitive values relating to position data associated with the object as compared to previous position data 130 stored in memory 120 to determine a correct mapping of the current positions to the previous positions in order to track motion of the multiple objects. In particular, processor 118 retrieves the previous position data 130 and executes a center point calculator 132 to determine an center point for the current position data and an center point for the previous position data. The center points represent center positions relative to the positions of the multiple objects or relative to a geometric shape circumscribing the multiple objects. Processor 118 executes center point alignment instructions 134 to align the center points of the current position data to the previous position data, and executes distance calculator 136 to determine the relative distances between objects based on the aligned position data. Processor 118 then executes position index assignment instructions 138 to determine a new center point for the objects based on the position data. Processor 118 then communicates the indexed position data to host system 106 via I/O interface 122. Host system 106 may process or interpolate the indexed position data to determine a user input corresponding to the object moving relative to the touch-sensitive interface. In an example, processor 118 uses control logic 126 to scan rows 108 and columns 110 to detect changes in capacitance and thus instantaneous position of objects relative to the touch-sensitive interface 104.

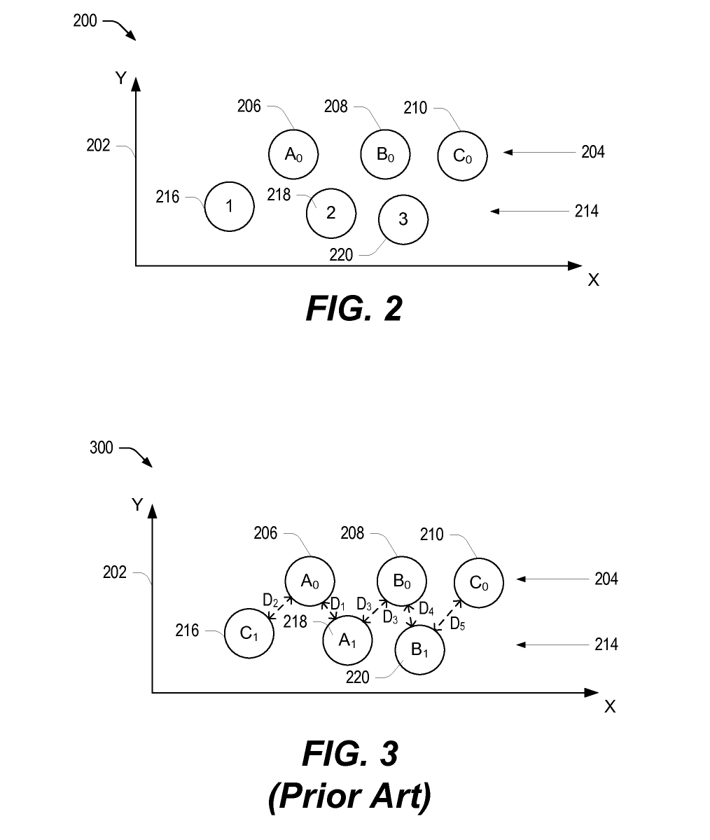

While the above-described integrated circuit 102 is configured to track multiple objects across a touch-sensitive interface, it should be appreciated that there is distinction between a distance-based indexing scheme and an index-point transpose followed by a distance-based indexing scheme. FIG. 2 below depicts current position data and previous position data for three objects. FIG. 3 depicts the distances and the re-indexing that can occur when a distance-based technique is used by itself.

FIG. 2 is a graph 200 illustrating previous position data 204 and current position data 214 for multiple objects on a touch-sensitive interface on an X-Y coordinate axis 202. Previous position data 204 includes object positions 206, 208, and 210, which are assigned to objects A, B, and C at a first time (t₀), resulting in an object index A₀, B₀, and C₀. Current position data 214 includes object positions 216, 218, and 220, which include objects 1, 2, and 3 at a second time (t₁), which objects are not yet assigned to the object index. In other words, the detection circuitry has not yet determined how the current position data 214 relates to the previous position data 204.

To track movement of objects, the current object positions 216, 218, and 220 may be mapped to the previous indexed positions 206, 208, and 210. Typically, the current indexed position would be mapped by a shortest distance technique in which the shortest distances between each current object position and each of the previous indexed positions are determined. The objects are then mapped based on the shortest distances, which can produce indexing errors, particularly when the object movement is fast or the data sampling rate is slow. In an example, the shortest distance calculation may lead to re-indexing and/or an incorrect determination that two objects arbitrarily changed position relative to the touch screen.

Turning now to FIG. 3, a graph 300 is depicted that illustrates the X-Y coordinate axis 202 and previous and current position data 204 and 214 together with distance calculations for the position data of FIG. 2, determined based on a conventional distance calculation, causing one of the objects to appear to change position arbitrarily. In particular, a distance between object position 206 and object position 218 is less than that between object position 206 and object position 216. Similarly, a distance between object position 208 and object position 220 is less than that between object position 208 and object position 218. Accordingly using the shortest distance algorithm, a control circuit may associate (index) object position 218 with previous object position 206, assigning the current object position 218 to object A at time (t₁), resulting in object position 218 being assigned to object index A₁. Similarly, a control circuit may associate object position 220 with a previous object position 208, assigning the current object position 220 to object B at time (t₁), resulting in object position 220 being assigned to object index B₁. In this instance, object position 216 is left out and is assigned to object index C₁. In this instance, object position 220 either becomes a new index or is remapped (as shown) to object position 210. To a user, it would appear that the objects associated with object positions 206 and 210 switched places.

For gesture inputs and for multi-touch inputs, such discontinuous mappings may result in erroneous user input and/or misinterpretation of user inputs, which can lead to user dissatisfaction with the device. However, as discussed below with respect to FIGS. 3-5, by utilizing an center point to transpose the current object positions and the previous object positions, the circuit 102 indexes the current object positions to the previous object positions based on the center point before calculating the distances, providing improved input recognition and reducing indexing irregularities.

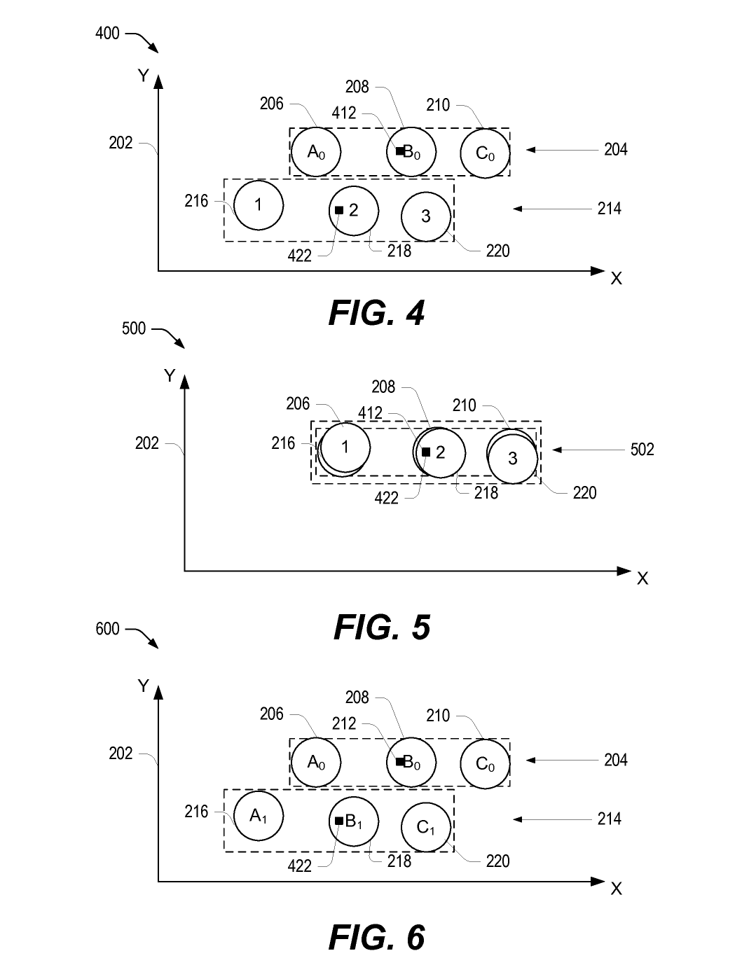

FIG. 4 is a graph 400 illustrating center points 412 and 422 of the previous position data 204 and the current position data 214, respectively of the position data 204 and 214 of FIG. 2. In the illustrated example, processor 118 used center point calculator 132 to calculate a center point 412 of the object positions 206, 208, and 210 of previous position data 204. Similarly, processor 118 used center point calculator 132 to calculate a center point 422 of the object positions 216, 218, and 220. The center points 412 and 422 correspond to center positions among the sets of object positions for the previous position data 204 and the current position data 214, respectively. In a particular example, the center positions are determined from centers of geometric shapes that circumscribe the object positions.

FIG. 5 is a graph 500 illustrating a transposition 502 (alignment) of the current position data 214 to the previous position data 204 by aligning the center points 412 and 422 of FIG. 4. In an example, the center point 422 is shifted in the X-Y plane onto the center point 412, normalizing the current position data 214 to the previous position data to link the multiple objects of the current position data 214 to the multiple objects of the previous position data 204. Thus, processor 118 determines how the multiple objects of the current position data 214 relate to the multiple objects of the previous position data 204.

Once the center points 412 and 422 are aligned, the relative shifts of the objects, as indicated by the difference between previous object positions 206, 208, and 210 relative to current object positions 216, 218, and 220 can be readily calculated to determine the appropriate index (association or link). In particular, object position 216 corresponds to object A, object position 218 corresponds to object B, and object position 220 corresponds to object C, making it possible to index the current object positions 216, 218, and 220 correctly as discussed below with respect to FIG. 6.

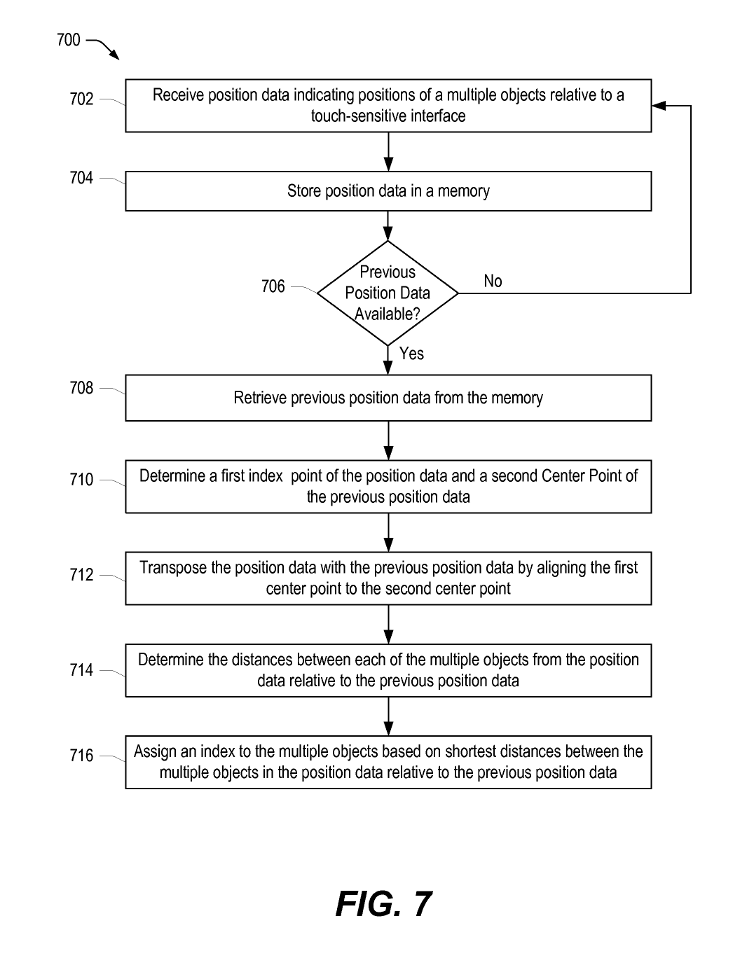

FIG. 6 is a graph 600 illustrating the resulting indexing of the current position data 216, 218, and 220 to the previous position data 206, 208, and 210 based on the distances between the objects determined from the transposed positions of FIG. 5. In particular, the shortest distances exist between object position 206 and object position 216 after the transposition 502. Accordingly, unlike in FIG. 3, the object position 216 is correctly indexed as object A at time (t₁), resulting in an object index of A₁. Similarly, object positions 218 and 220 are correctly indexed to objects B and C at time (t₁), resulting in an object index of B₁ and C₁, respectively. An example of one possible embodiment of tracking multiple objects on a touch-sensitive interface is described below with respect to FIG. 7.

FIG. 7 is a flow diagram of a method 700 for tracking multiple objects on a touch-sensitive interface. At 702, position data is received from a touch-sensitive interface indicating positions of multiple objects relative to the touch-sensitive interface. Initially, the data may be received as an analog value of one or more capacitors, which value may be multiplexed and detected by a capacitive sensor, which produces a digital output value that is provided to a processor. Advancing to 704, the position data is stored in a memory. If at 706, previous position data is not available, the method 700 returns to 702 to receive more position data.

However, at 706, if previous position data is available, the method 700 proceeds to 708 and previous position data is retrieved from the memory. Continuing to 710, the processor 118 determines a first center point of the (current) position data and a second center point of the previous position data. Moving to 712, the processor 118 transposes the (current) position data with the previous position data by aligning the first center point to the second center point. In an example, the center points are aligned in an X-Y plane.

Proceeding to 714, processor 118 determines the distances between each of the multiple objects from the (current) position data relative to the previous position data. After the transpose in 712, processor 118 can resolve ambiguities with respect to shortest distances that might otherwise result in a discontinuity, re-indexing, or error because the relative position of the objects is preserved, and thus the position-to-object correlation is also maintained.

Continuing to 716, processor 118 assigns an index to the multiple objects based on the shortest distances between the multiple objects of the (current) position data relative to the previous position data. In particular, the shortest distances after the transpose operation represent the relative correspondence between the current positions and the previous positions, in part, because aligning the center points normalizes the position data, allowing processor 118 to relate the current position data to the previous position data for the purpose of determining correspondence between previously detected objects and currently detected objects for tracking motion.

In the above-discussion, the embodiments have focused on center points. However, the center points are index points that represent a relative position of the multiple objects and that can be used to transpose current position data with previous position data before assigning or mapping object positions to facilitate tracking of movements relative to the touch-sensitive interface. In one instance, the center point is an index point that represents a minimum distance relative to each of the multiple objects. In another instance, the center point represents an index point that is a center of a geometric shape that circumscribes the multiple objects.

In conjunction with the circuits and methods described above with respect to FIGS. 1-7, a circuit is disclosed that includes an interface adapted to couple to a capacitive array of a touch-sensitive interface for receiving electrical signals corresponding to a position of one or more objects relative to the touch-sensitive interface. The circuit further includes a capacitive sensor circuit coupled to the interface and adapted to detect changes in capacitance within the capacitive array and to generate an output signal indicating current position data in response to detecting the changes. The circuit also includes a processor coupled to the capacitive sensor circuit. The processor is configured to transpose the current position data with previous position data and to assign an index to the current position data based on the distance between the one or more objects of the current position data relative to the one or more objects within the previous position data. The processor can provide the correctly indexed position data to a host system 106, which can interpolate the indexed position data to receive user input.

Although the present invention has been described with reference to preferred embodiments, workers skilled in the art will recognize that changes may be made in form and detail without departing from the scope of the invention.

What is claimed is:

1. An integrated circuit comprising:
a processor configured to receive position data corresponding to positions of objects relative to a touch-sensitive interface, the processor configured to determine a first index point for the position data and a second index point of previous position data corresponding to previous positions of the objects relative to the touch-sensitive interface, the processor to align the first and second index points and to assign an index to link the positions of the objects to the previous positions based on distances between the objects in the position data relative to the previous position data.

2. The integrated circuit of claim 1, further comprising:
an interface configurable to couple to a touch-sensitive array external to the integrated circuit; and
a sensor circuit coupled to the interface, the sensor circuit to sense a change in an electrical parameter corresponding to positions of objects relative to the touch-sensitive interface and to generate position data corresponding to the positions of the objects.

3. The integrated circuit of claim 1, wherein the processor determines movement of the objects based on changes in the position data relative to the previous position data.

4. The integrated circuit of claim 1, further comprising:
a memory to store the previous position data; and
wherein the processor retrieves the previous position data from the memory.

5. The integrated circuit of claim 4, wherein the memory further comprises instructions that, when executed, cause the processor to:
calculate the first and second index points, the first index point representing a first center point among the positions of the objects and the second index point representing a second center point among the previous positions of the objects;
align the position data and the previous position data based on the first and second center points;
determine a distance between the objects in the position data and the objects in the previous position data after aligning the position data and the previous position data; and
linking the objects of the position data with the objects in the previous position data to assign the index.

6. The integrated circuit of claim 1, further comprising an input/output interface coupled to the processor and configured to couple to a host system.

7. The integrated circuit of claim 1, wherein the sensor circuit comprises:
a control logic circuit including an input coupled to the processor and including an output;
a capacitive sensor including a sensor input and including a sensor output coupled to the processor; and
a multiplexer including a plurality of data inputs configurable to couple to the touch-sensitive interface, a control input coupled to the output of the control logic circuit, and an output coupled to the sensor input.

8. The integrated circuit of claim 1, wherein the first index point comprises a position defined by an X-coordinate and a Y-coordinate that is at a center point between the positions of the objects in an X-dimension and a Y-dimension, respectively.

9. A method of tracking multiple objects relative to a touch sensitive interface, the method comprising:
determining a first center point among the multiple objects from first position data captured at a first time;
determining a second center point among the multiple objects from second position data captured at a second time;
transposing the second position data with the first position data based on the first center point and the second center point to form aligned position data; and
assigning an index to relate the multiple objects of the first position data to the multiple objects of the second position data based on their relative distances within the aligned position data.

10. The method of claim 9, wherein transposing the second position data with the first position data comprises aligning the first center point with the second center point to shift one of the first position data and the second position data.

11. The method of claim 9, wherein assigning the index comprises mapping multiple objects of the second position data to the multiple objects of the first position data.

12. The method of claim 9, wherein, before assigning the index, the method further comprises determining the distances between the multiple objects in the first position data and the multiple objects in the second position data.

13. The method of claim 12, further comprising associating a first position of a first object within the first position data with a second position of the first object within the second position data.

14. The method of claim 9, further comprising communicating the index to a host system.

15. A system comprising:
a touch-sensitive interface for receiving user input; and
an integrated circuit coupled to the touch-sensitive interface, the integrated circuit comprising:
an interface configurable to couple to the touch-sensitive interface;
a sensor circuit coupled to the interface, the sensor circuit to sense a change in an electrical parameter corresponding to positions of multiple objects relative to the touch-sensitive interface and to generate position data corresponding to the positions of the multiple objects; and
a processor coupled to the sensor circuit and configured to relate first position data from a first time and second position data from a second time to determine relative motion of the multiple objects, the processor to align a first center point of the first position data with a second center point of the second position data, to calculate distances between the multiple objects in the first and second position data, and to link the multiple objects in the second position data to the multiple objects in the first position data based on the distances.

16. The system of claim 15, wherein the touch-sensitive interface comprises a touch-screen including a capacitive array for receiving the user input.

17. The system of claim 15, further comprising a memory coupled to the processor for storing position data including the first position data and for storing instructions that, when executed by the processor, cause the processor to track movement of the multiple objects relative to the touch-sensitive interface over time.

18. The system of claim 15, wherein the processor links the multiple objects in the second position data to the multiple objects in the first position data based on a minimum distance after the processor aligns the first and second center points.

19. The system of claim 15, wherein the processor aligns the first and second center points by shifting the second position data as a group such that the second center point is aligned to the first center point.

20. The system of claim 15, wherein the first center point comprises a position defined by an X-coordinate and a Y-coordinate that is at a center-point between the positions of the multiple objects in an X-dimension and a Y-dimension, respectively.
